(19) United States
(12) Patent Application Publication
(10) Pub. No.: US 2019/0157011 A1
(43) Pub. Date: May 23, 2019

(54) METHOD FOR PRODUCING LOW-OXYGEN VALVE-METAL SINTERED BODIES HAVING A LARGE SURFACE AREA

(71) Applicant: H.C. STARCK TANTALUM AND NIOBIUM GMBH, Muenchen (DE)

(72) Inventors: Helmut Haas, Achim (DE); Marcel Hagymasi, Vienenburg (DE); Christine Rawohl, Langelsheim (DE)

(73) Assignee: H.C. STARCK TANTALUM AND NIOBIUM GMBH, Muenchen (DE)

(21) Appl. No.: 16/252,723

(22) Filed: Jan. 21, 2019

Related U.S. Application Data
(62) Division of application No. 14/781,913, filed on Oct. 2, 2015.

(30) Foreign Application Priority Data
Apr. 12, 2013 (DE) 10 2013 206 603.1

(51) Int. Cl. H01G 9/00; C22C 1/04; B22F 3/26; B22F 3/12; H01G 9/052; H01G 9/15

(52) U.S. Cl. CPC H01G 9/0029; C22C 1/045; C22C 1/04; B22F 3/26; B22F 2998/10; H01G 9/052; H01G 9/15; H01G 9/0525; B22F 2304/056; B22F 3/12

(57) ABSTRACT

A sintered body obtainable by a process which includes pressing a powder comprising or consisting of at least one valve metal so as to provide a pellet, providing the pellet together with a reducing agent so that the pellet is not in a direct contact with and does not come into a direct contact with the reducing agent, heating so that the powder in the pellet is sintered to form a sintered body, an oxygen content of the at least one valve metal within the sintered body is simultaneously reduced, and the reducing agent is oxidized to an oxidized reducing agent, and removing the oxidized reducing agent with at least one mineral acid.

### CROSS REFERENCE TO PRIOR APPLICATIONS

This application is a divisional of U.S. application Ser. No. 14/781,913, filed on Oct. 2, 2015. U.S. application Ser. No. 14/781,913 is a U.S. National Phase application under 35 U.S.C. § 371 of International Application No. PCT/EP2014/057244, filed on Apr. 10, 2014 and which claims benefit to German Patent Application No. 10 2013 206 603.1, filed on Apr. 12, 2013. The International Application was published in German on Oct. 16, 2014 as WO 2014/167045 A2 under PCT Article 21(2).

### FIELD

The present invention relates to a process for producing sintered bodies (sintered pellets) from valve metals, the sintered bodies having a low oxygen content and good anodizability despite of their high surface area. The present invention further relates to sintered bodies obtainable by the process and to the use thereof for electronic components, especially capacitors. The present invention also relates to a valve metal powder which is particularly suitable for use in the process described.

### BACKGROUND

Solid electrolytic capacitors having very large active capacitor area and a small design suitable for mobile communications electronics are predominantly capacitor modules having a tantalum pentoxide barrier layer which have been applied to an appropriate conductive tantalum metal carrier. This exploits the stability of the metal (“valve metal”), the comparatively high dielectric constants, and the insulating pentoxide layer producible with very homogeneous layer thickness via electrochemical production. The metallic carrier, which is simultaneously the anode of the capacitor, consists of a high-porosity, sponge-like structure which is produced by pressing and sintering of ultrafinely divided primary structures or already sponge-like secondary structures. The mechanical stability of the pressed body is the key to the further processing thereof to provide the sintered body, the actual carrier structure, or anode of the capacitor. The surface of the support structure is oxidized electrolytically to amorphous pentoxide (anodic oxidation; “formation”), the thickness of the pentoxide layer being determined by the maximum voltage of the electrolytic oxidation (“formation voltage”). The counterelectrode is produced by impregnating the sponge-like structure with manganese nitrate, which is converted thermally to manganese dioxide, or with a liquid precursor of a polymer electrolyte and polymerization.

The contacts with the electrodes are formed on the cathodic side via a layer structure composed of graphite and conductive silver at the output conductor in the form of a ribbon or wire, and on the anodic side via a wire made from tantalum or niobium, this wire typically being inserted into the mold prior to the sintering operation and being led out of the capacitor. The strength with which the wire was sintered to the anode structure (tear-out strength or wire pull strength) is a key property for the further processing to form the capacitor.

A general problem in the production of such sintered bodies is the control of the oxygen content, which influences the properties of the capacitor produced therefrom, particularly when tantalum is used. Numerous studies demonstrate the adverse effect of oxygen on the properties of the finished tantalum capacitor. An elevated oxygen content can lead to unwanted crystallization of the amorphous tantalum oxide which is built up during the formation of the sintered tantalum body. While amorphous tantalum oxide is an excellent insulator, crystalline tantalum oxide has at least a low electrical conductivity, which leads to failures of the capacitor because of elevated leakage current or breakdowns. Since tantalum has a natural passive layer of tantalum oxide which prevents further oxidation of the metal, oxygen cannot be entirely eliminated; its contents can at best be minimized. An oxygen content of about 3000 ppm*g/m² is required for passivation since the tantalum powder would otherwise become pyrophoric and would burn off on contact with the ambient air. The natural oxide layer of tantalum has a thickness of about 1 to 2 nm, which corresponds to an oxygen content of about 3000 ppm*g/m², and which in turn would make up, for example, a content of around 0.6% in a powder having a specific surface area of 2 m²/g. Even tantalum powder described as “oxygen-free” in the literature therefore always has at least this oxygen content (see, for example, Y. Freeman et al, J. Electrochem. Soc. 2010, vol. 157, no. 7, G161; J. D. Sloppy, Pennsylvania State University, Thesis 2009, p. 180; Q. Lu, S. Mato, P. Skeldon, G. E. Thompson, D. Masheder, Thin Solids Films 2003, 429 (1-2), 238; G. Battistig, G. Amsel, E. D'artemare, Nuclear Instruments & Methods in Physics Research B, 1991, 61, 369-376; L. Young, Trans. Faraday Soc. 1954, 50, 153-159; V. Macagno, J. W. Schultze, J. Electroanal. Chem. 1984, 180, 157-170; and O. Kerrec in Transfert Electronique pour les systems de type M.O.E. modification des electrodes par constitution de structures de type M.O.M, Chimie 1992, Paris). The problem is more serious for sintered bodies having large surface areas since the oxygen content is directly proportional to the surface area of the tantalum substrate.

WO 02/45109 A1 describes a process for producing tantalum or niobium capacitors which comprises, as well as the sintering and the deoxidation, doping of the sintered body with nitrogen. These sintered bodies are produced in an oxygen-free atmosphere.

U.S. Pat. No. 4,722,756 describes a process for reducing the oxygen content in sintered tantalum or niobium bodies. The pellets are here sintered in a hydrogen atmosphere in the presence of a reducing material. The reducing material may consist of beryllium, calcium, cerium, hafnium, lanthanum, lithium, praseodymium, scandium, thorium, titanium, uranium, vanadium, yttrium or zirconium, and alloys or mixtures thereof.

DE 33 09 891 C2 describes a two-stage process for producing sintered valve metal anodes for electrolytic capacitors in which the already sintered tantalum body is deoxidized in the presence of a reducing metal such as magnesium. This involves introducing the metal into a reaction chamber together with the sintered bodies and heating them together to temperatures between 650° C. and 1150° C.

WO 2009/140274 A2 describes an anode wherein the inner portion has a higher density than the outer portion. This is intended to improve the wire bonding. For deoxidation of the pellet, magnesium is supplied thereto, the process temperatures being high enough to vaporize the magnesium.

DE 31 30 392 A1 describes a process for producing pure agglomerated valve metal powders in which the thermal agglomeration is conducted at relatively low temperatures in the presence of a reducing agent such as aluminum, beryllium, calcium or magnesium. For this purpose, the valve metal powder is mixed vigorously with magnesium powder, for example, and the mixture is pressed to shaped bodies having a cylindrical shape, which are then sintered at temperatures between 1200° C. and 1400° C.

Even though the oxygen content of sintered bodies made from tantalum can be lowered by a thermal aftertreatment under reducing conditions or by sintering of the green bodies under reducing conditions, these methods result in a loss or at least in a distinct deterioration in the bonding of the sintered body to the embedded wire. The resulting deterioration in electrical properties of the anode body then leads to complete failures or at least significant yield losses in the capacitor.

### SUMMARY

An aspect of the present invention is to provide a process for producing sintered valve metal bodies having a low oxygen content and simultaneously having good wire bonding. It is thereby possible to produce capacitors having a low leakage current with simultaneously high capacitance. An additional aspect of the present invention is to provide a process for producing sintered valve metal bodies which has a shorter process duration compared to conventional processes for producing low-oxygen sintered valve metal bodies.

An additional aspect of the present invention is to provide a valve metal powder which is particularly suitable for use in the process according to the present invention, and which leads to improved sintering properties and enhanced bonding of the wire to the sintered body.

In an embodiment, the present invention provides a sintered body which is obtainable by a process which includes pressing a powder comprising or consisting of at least one valve metal so as to provide a pellet, providing the pellet together with a reducing agent so that the pellet is not in a direct contact with and does not come into a direct contact with the reducing agent, heating so that the powder in the pellet is sintered to form a sintered body, an oxygen content of the at least one valve metal within the sintered body is simultaneously reduced, and the reducing agent is oxidized to an oxidized reducing agent, and removing the oxidized reducing agent with at least one mineral acid.

### BRIEF DESCRIPTION OF THE DRAWINGS

The present invention is described in greater detail below on the basis of embodiments and of the drawings in which:

FIG. 1 shows a secondary electron microscope image of the sintered body described in Example 5; and

FIG. 2 shows a secondary electron microscope image of the sintered body used as Comparative Example 3 in Table 4.

### DETAILED DESCRIPTION

In an embodiment, the present invention provides a process for producing a sintered body comprising the following steps:
a) pressing a powder comprising or consisting of valve metals;
b) providing the pellet obtained in step a) together with a reducing agent so that the pellet is not in direct contact and does not come into direct contact with solid or liquid reducing agent;
c) heating so that the powder is sintered to form a sintered body and the oxygen content of the valve metal within the sintered body is simultaneously reduced; and
d) removing the oxidized reducing agent with the aid of mineral acids.

The valve metal powders can, for example, be of high purity, particularly in terms of the contents of impurities that can adversely affect the leakage current. The sum total of the contents of sodium and potassium can, for example, be below 5 ppm, for example, below 2 ppm. The sum total of the contents of iron, chromium and nickel can, for example, be below 25 ppm, for example, below 15 ppm. The ppm figures are each based on parts by mass.

An objective in mobile communications electronics is to satisfy the market for components which attain high performance, but which may only have a small size. An embodiment of the process according to the present invention can therefore be one in which, for example, the powder is pressed to small shaped bodies (pellets).

In order to assure efficient running of the process, the pellets should, for example, be produced with the aid of automatic presses. Since the proportion of fines in the powder likewise increases with increasing surface area of the powder, an increasing risk exists that the press mold could become blocked or even be damaged. In an embodiment of the process, the powder can, for example, comprise pressing aids. These pressing aids act as binders. In an embodiment, when the valve metal powder comprises pressing aids, there can, for example, be an additional debinding step (debindering step) between steps a) and b) of the process according to the present invention.

The pressing aid can, for example, be selected from the group consisting of polyacrylic esters, polyethylene glycol, camphor, polyethylene carbonate, and stearic acid. The pressing aid can, for example, be selected in terms of nature and amount so that it can penetrate efficiently into the powder to be pressed on the one hand, but on the other hand can again also be removed with a low level of difficulty after the pressing operation.

If pressing aids are used, an embodiment of the process according to the present invention can, for example, include the pressing aid again being removed from the pellet after the pressing operation. This debinding operation can be effected, for example, thermally, for example, by vaporizing the pressing aid or thermolysis, or via alkaline hydrolysis. The debinding method can, for example, be selected so that the content of carbon remaining within the powder is as low as possible in order to avoid impairment of the later capacitor.

In an embodiment of the present invention, the carbon content of the sintered body can, for example, be below 200 ppm (parts per million), for example, below 100 ppm, for example, below 50 ppm, and for example, below 40 ppm and above 1 ppm, based each case on parts by mass.

In an embodiment of the process according to the present invention, the powder can, for example, be pressed up to a green density of 4.5 g/cm³ to 9 g/cm³, for example, of 5 g/cm³ to 8 g/cm³, for example, of 5.5 g/cm³ to 7.5 g/cm³, for example, of 5.5 g/cm³ to 6.5 g/cm³.

An important constituent of a capacitor is the electrical contacts to the electrodes. The contacts with the electrodes are formed on the cathodic side by a layer structure composed of graphite and conductive silver at the output conductor in the form of a ribbon or wire, and on the anodic side by a wire made from tantalum or niobium, this wire typically being inserted into the mold prior to the sintering operation and being led out of the capacitor. The strength with which the wire has been sintered within the anode structure, and thus within the sintered body, i.e., the bonding of the wire to the anode body, is a key property for the further processing of the sintered body to form the capacitor. An embodiment of the process according to the present invention thus provides, for example, that the powder is pressed around a wire, for example, a wire made from a valve metal.

In an embodiment of the process according to the present invention, the wire can, for example, be bound by welding to the sintered body.

The valve metal of the wire can, for example, be selected from the group consisting of tantalum and niobium. The valve metal powder which is pressed around the wire comprising a valve metal can, for example, be selected from the group consisting of tantalum and niobium. Both the wire and the powder comprising a valve metal can, for example, be selected from the group consisting of tantalum and niobium.

In an embodiment of the process according to the present invention, the valve metal powder can, for example, consist of agglomerated primary particles having a minimum dimension of 0.05 to 0.4 μm. The primary particles can, for example, have a specific surface area within a range from 1.5 to 20 m²/g, the specific surface area having been determined to ASTM D3663. The particle size distribution of the valve metal powder can, for example, have a D10 determined to ASTM B822 of 2 to 80 μm, for example, 2 to 30 μm. The valve metal powder can, for example, have a D50 between 10 and 200 μm, for example, between 15 and 175 μm. The valve metal powder can, for example, have a D90 in the range between 30 and 400 μm, for example, between 40 and 300 μm. Both the D50 and the D90 can be determined, for example, to ASTM B822.

In an embodiment of the process according to the present invention, the valve metal powder can, for example, have a BET surface area of 1.5 m²/g to 20 m²/g, for example, 2.0 m²/g to 15 m²/g, for example, 3.0 m²/g to 10 m²/g, for example, 4.0 m²/g to 8.0 m²/g. BET surface area in the context of the present invention refers to the specific surface area determined by the method of Brunauer, Emmett and Teller (DIN ISO 9277).

In order to achieve a maximum active surface area, it can, for example, be advantageous to use a powder having maximum open porosity. The blockage of pores or the formation of closed pores, for example, as a result of excessive sintering, leads to the loss of active capacitor surface area. This loss can be prevented by the use of anti-sintering doping with nitrogen and/or phosphorus, and previously also boron, silicon, sulfur or arsenic. An excessively high concentration of anti-sintering doping, however, results in a reduction in sintering activity, which is sometimes significant. An embodiment of the process according to the present invention is therefore provided in which the valve metal powder can, for example, have a phosphorus content of less than 20 ppm, for example, between 0.1 and less than 20 ppm, based in each case on parts by mass.

In an embodiment of the process according to the present invention, the valve metal powder can, for example, have a minimum content of substances known for their anti-sintering effect. The valve metal powder can, for example, be free of any effective content of anti-sintering agents.

In an embodiment of the present invention, the valve metal powder can, for example, have a nitrogen content below 300 ppm, for example, below 300 ppm and above 0.1 ppm, based in each case on parts by mass.

In an embodiment of the present invention, the valve metal powder can, for example, have a boron content below 10 ppm, for example, below 10 ppm and above 0.01 ppm, based in each case on parts by mass.

In an embodiment of the present invention, the valve metal powder can, for example, have a sulfur content below 20 ppm, for example, below 10 ppm and above 0.1 ppm, based in each case on parts by mass.

In an embodiment of the present invention, the valve metal powder can, for example, have a silicon content below 20 ppm, for example, below 20 ppm and above 0.01 ppm, based in each case on parts by mass.

In an embodiment of the present invention, the valve metal powder can, for example, have an arsenic content below 10 ppm, for example, below 10 ppm and above 0.01 ppm, based in each case on parts by mass.

In an embodiment of the present invention, the valve metal powder can, for example, have a phosphorus content below 20 ppm and above 0.1 ppm, a nitrogen content below 300 ppm and above 0.1 ppm, a boron content below 10 ppm and above 0.01 ppm, a sulfur content below 20 ppm and above 0.1 ppm, a silicon content below 20 ppm and above 0.01 ppm, and an arsenic content below 10 ppm and above 0.01 ppm, based in each case on parts by mass.

Valve metals are notable in that their oxides block current in one direction but allow it to pass in the other direction. These valve metals include, for example, tantalum, niobium, and aluminum. A valve metal in the context of the present invention may also be an alloy. A further feature of the valve metal is that they have a passive layer of valve metal oxide which prevents further oxidation and hence ignition of the metal. The oxygen content is based on the specific surface area of the powder, i.e., the quotient of oxygen content in ppm based on parts by mass and the specific surface area measured according to BET.

Typical representatives of the valve metals are selected from the group consisting of Al, Bi, Hf, Nb, Sb, Ta, W and Zr. Also possible are alloys of these valve metals with one another. In an embodiment, valve metals in the context of the present invention can, for example, also be alloys of the aforementioned valve metals, these being with further metals selected, for example, from the group consisting of Be, Ge, Mg, Si, Sn, Ti and V.

Alloys of valve metals with further, non-valve metals, in which the proportion of the valve metal is at least 50% by weight, for example, at least 70% by weight, and for example, at least 90% by weight, for example, at least 95% by weight or at least 98.5% by weight, or at least 99.5% by weight, of the overall alloy can, for example, be used.

Valve metals in the context of the present invention can, for example, be tantalum and niobium.

In an embodiment of the process according to the present invention, the valve metal powder can, for example, have an oxygen content above 3000 ppm*g/m², for example, above 3500 ppm*g/m², and for example, between 4100 ppm*g/m² and 8000 ppm*g/m², based in each case on parts by mass. The oxygen content was determined by means of carrier gas reactive fusion with the Nitrogen/Oxygen Determinator Model TCH 600 instrument from Leco Instrumente GmbH.

In an embodiment of the process according to the present invention, the valve metal powder can, for example, have a median particle diameter D50 of 15 to 175 μm, for example, 20 to 100 μm, the median particle diameters having been determined to ASTM B822.

It has surprisingly been found that the use of the valve metal powders having elevated oxygen content and a low and defined amount of sintering inhibitors significantly increased both the bonding of the wire to the sintered body and the sinterability.

The present invention therefore further provides a valve metal powder comprising the following components:
i) oxygen in an amount of more than 4100 ppm·g/m², for example, between 4100 ppm·g/m² and 8000 ppm·g/m²;
ii) optionally nitrogen in an amount below 300 ppm, for example, between 0.1 ppm and 300 ppm;
iii) optionally boron in an amount below 10 ppm, for example, between 0.01 ppm and 10 ppm;
iv) optionally sulfur in an amount below 20 ppm, for example, between 0.1 ppm and 10 ppm;
v) optionally silicon in an amount below 20 ppm, for example, between 0.01 ppm and 20 ppm;
vi) optionally arsenic in an amount below 10 ppm, for example, between 0.01 ppm and 10 ppm; and
vii) optionally phosphorus in an amount below 20 ppm, for example, between 0.1 ppm and 20 ppm, where the ppm values are each based on parts by mass.

A valve metal powder of the present invention can, for example, comprise the following components:
i) oxygen in an amount of more than 4100 ppm·g/m², for example, between 4100 ppm·g/m² and 8000 ppm·g/m²;
ii) nitrogen in an amount below 300 ppm, for example, between 0.1 ppm and 300 ppm;
iii) boron in an amount below 10 ppm, for example, between 0.01 ppm and 10 ppm;
iv) sulfur in an amount below 20 ppm, for example, between 0.1 ppm and 10 ppm;
v) silicon in an amount below 20 ppm, for example, between 0.01 ppm and 20 ppm;
vi) arsenic in an amount below 10 ppm, for example, between 0.01 ppm and 10 ppm; and
vii) phosphorus in an amount below 20 ppm, for example, between 0.1 ppm and 20 ppm, where the ppm values are each based on parts by mass.

The oxygen content of the inventive valve metal powders is above the oxygen content of prior art valve metal powders, and so is above the customary, i.e., natural, oxygen content which leads to the formation of an oxide layer on the metal surface through the contact of the metal with ambient air. The elevated oxygen content of the inventive valve metal powder can be established in a specific manner, for example, through treatment of the metal powder with oxygen.

It has surprisingly been found that a powder of the composition described has improved sinterabilities and hence improved wire bonding to the sintered body. By virtue of the elevated oxygen content in the valve metal powder compared to the prior art, higher temperatures are obtained within the pellet during the sintering operation, as a result of which better bonding of the wire to the sintered body is achieved.

In an embodiment of the present invention, the valve metal powder can, for example, have a BET surface area of 1.5 m²/g to 20 m²/g, for example, 2.0 m²/g to 15 m²/g, for example, 3.0 m²/g to 10 m²/g, for example, 4 m²/g to 8 m²/g.

In an embodiment of the present invention, a valve metal powder is provided which, for example, consists of agglomerated primary particles having a dimension of 0.05 to 0.4 μm. The primary particles can, for example, have a specific surface area within a range from 1.5 to 20 m²/g, the specific surface area having been determined to DIN ISO 9277. The particle size distribution of the valve metal powder can, for example, have a D10 determined to ASTM B822 of 2 to 80 μm, for example, 2 to 30 μm. The valve metal powder can, for example, have a D50 between 10 and 200 μm, for example, between 15 and 175 μm. The valve metal powder can, for example, have a D90 in the range between 30 and 400 μm, for example, between 40 and 300 μm. Both the D50 and the D90 can be determined, for example, to ASTM B822.

The inventive valve metal powder can, for example, be selected from niobium and/or tantalum.

In an embodiment of the present invention, the inventive valve metal powders can, for example, be used, i.e., pressed, in step a) of the process according to the present invention.

The valve metal powders can, for example, be of high purity, especially in terms of the contents of impurities that can adversely affect the leakage current. The sum total of the contents of sodium and potassium can, for example, be below 5 ppm, for example, below 2 ppm. The sum total of the contents of iron, chromium and nickel can, for example, be below 25 ppm, for example, below 15 ppm. The ppm figures are each based on parts by mass.

An elevated oxygen content in capacitors leads to poorer electrical properties. It is, for example, possible for an elevated oxygen content to cause the originally amorphous oxide of the valve metal to be converted to a crystalline form, which, however, has a relatively high electrical conductivity. In this way, the insulating effect of the dielectric decreases and the capacitor increasingly has what is called a leakage current. As well as the natural oxygen content which results from the passivation of the metal, there is a further incorporation of oxygen during the sintering of the pellet under non-reducing conditions. It is therefore important to reduce the oxygen content in the pellet during the sintering. This is of particular significance especially since the pellet shrinks during the sintering operation, which reduces its surface area, which in turn leads to an excess of oxygen in the porous metal composite. As a result of the elevated temperatures during the sintering, much more oxygen can be incorporated into the metal lattice up to the saturation limit than would be the case at room temperature. This incorporation leads to expansion of the metal lattice. As soon as a critical value is exceeded, crystalline valve metal oxide precipitates out, which causes the adverse effects described, for example, elevated leakage currents. An embodiment of the process according to the present invention therefore provides that the sintering of the pellet is, for example, combined with simultaneous deoxidation.

Deoxidation in the context of the present invention is the removal of excess oxygen from already reduced metals, for example, from the metal lattice.

In an embodiment of the process according to the present invention, the pellet can, for example, be sintered in a reducing atmosphere. Processes known from the prior art are the mixing of the powder with a reducing agent or the simultaneous heating of the reducing agent together with the sintered bodies. These methods have the disadvantage, however, that the deoxidation thus conducted leads to poor wire bonding, the extent of which can be such that the wire is detached from the sintered body during the further processing operations and the production of an anodic oxide layer on the sintered body or, thereafter, a measurement of the electrical properties of the anode thus obtained is no longer possible. The present invention therefore provides a process in which the oxygen content is lowered, while there is simultaneously a sufficiently firm bonding of the wire to the sintered body.

In an embodiment of the process according to the present invention, the reducing agent in solid or liquid form can, for example, be spatially separate from the valve metals. An embodiment of the present invention provides that the reducing agent can, for example, be vaporized. As soon as the desired temperature has been attained, the pellet, which can, for example, be within a basket made from perforated niobium or tantalum sheet, is immersed into the vapor so that the oxygen in the pellet can react with the reducing agent. The dipping operation of the process according to the present invention can, for example, allow higher temperatures within the pellet to be achieved, which leads to a greater shrinkage of the pellet, and hence to a higher densification. It has surprisingly been found that this effect occurs particularly in the case of use of the inventive valve metal powders having an oxygen content above 4100 ppm*g/m². The ultimate shrinkage of the pellet can be determined by the temperature and the duration of deoxidation.

In an embodiment of the process according to the present invention, the magnesium can, for example, be placed onto a tablet. Above it is suspended a perforated sheet of tantalum or niobium on which the pellets are present. In this case, the distance between the tablet with the magnesium and the perforated niobium sheet may, for example, be between 4 and 8 cm. The tablet on which the magnesium is present is heated. The oxygen in the pellets reacts as soon as it comes into contact with the magnesium vapor.

In an embodiment of the present invention, the reducing agent and the pellet can, for example, be within the same process chamber, but spatially separated from one another. In this case, the reducing agent can, for example, first be vaporized, and the pellet then contacted with the vapor, for example, by suspending the pellet in the vapor. This dispenses with laborious diversion or onward passage of the vapor from one process chamber to another, which in turn saves time. The immersion of the pellet into the vapor furthermore prevents the pellet from losing too much specific surface area.

It has here too surprisingly been found that the use of the inventive valve metal powder having an oxygen content above 4100 ppm*g/m² promotes the bonding of the wire to the sintered body.

In an embodiment of the process according to the present invention, the deoxidation of the pellet can, for example, be effected under an inert carrier gas, for example, argon, the reduction being effected at a partial vapor pressure of the reducing metal of 5 to 650 hPa, for example, more than 40 hPa, for example, between 100 and 400 hPa. The inert gas pressure can, for example, be in a range of from 50 to 800 hPa, for example, less than 600 hPa, for example, between 100 and 500 hPa.

In an embodiment of the process according to the present invention, the reduction in the oxygen content of the valve metal within the sintered body can, for example, be effected at pressures below atmospheric pressure, for example, at a gas pressure of 50 to 800 hPa, for example, below 600 hPa, for example, between 100 and 500 hPa.

In an embodiment of the process according to the present invention, the heating, which leads to sintering and the reduction in the oxygen content, can, for example, be effected at temperatures in the range from 800° C. to 1400° C., for example, from 900° C. to 1200° C., for example, from 900° C. to 1100° C. The temperature range can, for example, be selected so that the oxygen content of the sintered body falls to the desired degree. Oxygen is generally known to inhibit the sintering of a pellet. The lowering of the oxygen content results in a more effective sintering of the powder particles to one another and of the powder particles and the embedded wire at lower temperatures than are generally customary.

In an embodiment of the process according to the present invention, the reducing agent can, for example, be selected from lithium and alkaline earth metals, for example, magnesium or calcium.

The oxidation product of the reducing agent formed during the deoxidation, if it has not already evaporated during the sintering, is washed out of the sintered body with the aid of dilute mineral acid. In order to avoid additional mechanical stress on the sintered bodies, they can, for example, be placed onto a perforated niobium or stainless steel sheet which is introduced into the washing vessel together with the washing liquid. The solution is stirred, and the stirring speed can, for example, be adjusted so that the sintered bodies do not start to move during the washing operation. The oxidation product of the reducing agent can, for example, be magnesium oxide in the composition MgO. Mineral acids in the context of the present invention are acids which do not contain any carbon, for example, hydrochloric acid, sulfuric acid, nitric acid or phosphoric acid.

The deoxidation and the subsequent washing operation reduce the strength with which the embedded wire is sintered within the sintered body (wire pull strength). The bonding of the wire to the sintered body can decrease to such an extent that the wire is pulled out of the sintered body or breaks off during the further processing of the sintered body. It has surprisingly been found, however, that the use of the inventive valve metal powder having an oxygen content above 4100 ppm*g/m² can further enhance the bonding of the wire to the sintered body. In other cases, the bonding is so low that it is not possible to conduct any electrical measurements and the sintered body becomes unusable as a capacitor. As is known to those skilled in the art, the problem is counteracted according to the prior art by re-sintering the deoxidized and washed sintered body. This does increase the wire bonding to the anode body, but at the same time, the oxygen content in the sintered body again rises.

In an embodiment of the process according to the present invention, the oxygen content of the deoxidized sintered body can, for example, be in the range between 2400 and 3600 ppm*g/m², where the ppm figures are each based on parts by mass. The oxygen content was determined by means of carrier gas reactive fusion with the Nitrogen/Oxygen Determinator Model TCH 600 instrument from Leco Instrumente GmbH.

Studies have shown that the hydrogen content of deoxidized and washed sintered bodies is distinctly increased compared to merely sintered bodies. As a result of the increased hydrogen content, not only does the brittleness of the embedded wire increase, but the entire sintered body also loses strength. In an embodiment of the process according to the present invention, the deoxidized and washed sintered body can, for example, be heated once again. The conditions here should, for example, be selected so that the hydrogen evaporates. It has surprisingly been found that sintered bodies that have been subjected to this additional degassing step have improved bonding of the embedded wire.

The bonding of the wire to the sintered body, i.e., the “wire pull strength”, was determined as follows: the anode wire was inserted through an orifice of diameter 0.25 mm of a holder plate and the free end was clamped into the holding clamp of a force gauge (Chatillon, model: DFGS-50 with LTCM-6 drive), and was subjected to a load until the wire was pulled out of the anode structure, i.e., the sintered body.

It has surprisingly been found that the wire bonding of the anode wire can be improved by forming the sintered body. An embodiment of the present invention therefore provides that the removal of the oxidized reducing agent in step d) of the process according to the present invention can, for example, be followed by the forming of the sintered body in a step e). Forming is a process familiar to those skilled in the art.

As already stated, the wire bonding of the anode wire to the sintered body is an important criterion which ultimately decides whether the sintered body is suitable for later use in capacitors. It has surprisingly been found that the wire bonding after deoxidation is very high, but declines significantly after the washing. It has moreover been found that the wire bonding after the forming of the sintered bodies is again at a level comparable to that after deoxidation and before washing. This is important in that there is mechanical stress on the anode wire prior to the forming, for example, resulting from welding onto the leadframe (incorporation of the anodes for immersion into the electrolyte and connection of the anodes to contacts). The mechanical stress can cause the wire to be pulled out, which makes the sintered body unsuitable for further processing, since subsequent securing of the anode wire is impossible. The washing operation after the deoxidation, in which the oxidized reducing agent is removed with the aid of mineral acids, furthermore increases the number of production steps required, which leads to higher economic expenditure and operational complexity.

In an embodiment of the process according to the present invention, the removal of the oxidized reducing agent from the sintered body can, for example, be accompanied by simultaneous forming thereof. In this way, the drop in the wire bonding can be avoided, while the process sequence is at the same time optimized. In an embodiment, the oxidized reducing agent can, for example, be removed in step d) with simultaneous forming.

In an embodiment of the process according to the present invention, the forming in step d) can, for example, be effected in the presence of a liquid electrolyte. In this case, the liquid electrolyte can, for example, be selected so that both effective washing of the oxidized reducing agent out of the sintered body and satisfactory forming thereof are provided. It has surprisingly been found that the oxidized reducing agent can be removed effectively, especially with the aid of mineral acids. The presence of oxidizing agents, for example hydrogen peroxide, can also have an advantageous effect on the washing outcome. Particularly the uptake of hydrogen during the washing can be reduced in this way. In the case of addition of hydrogen peroxide, it is additionally possible to lower the forming temperature to below 80° C.

In an embodiment of the present invention, the liquid electrolyte can, for example, comprise hydrogen peroxide (H₂O₂) as well as at least one mineral acid.

In an embodiment of the present invention, the mineral acid can, for example, be selected from the group consisting of sulfuric acid, phosphoric acid, hydrochloric acid, nitric acid, and mixtures thereof.

In an embodiment of the process according to the present invention, the liquid electrolyte can, for example, comprise one or more mineral acids in an amount of 0.1 to 10% by weight, for example, 1 to 8% by weight, for example, 3 to 6% by weight, based in each case on the total weight of the liquid electrolyte.

In an embodiment of the present invention, the liquid electrolyte can, for example, comprise hydrogen peroxide in an amount of 0.1 to 0.9% by weight, for example, 0.3 to 0.7% by weight, based in each case on the total weight of the liquid electrolyte.

In an embodiment of the process according to the present invention, the sintering step can, for example, be followed by a nitriding operation below 500° C., for example, between 200° C. and 400° C. In the course thereof, the sintered body is supplied with nitrogen, for example, during cooling. Since the surface of the sintered body contains only a little oxygen, the nitrogen can occupy a portion of the surface of the sintered body. The oxygen coverage of the surface is reduced in this way. The concentration of nitrogen in the sintered body can, for example, be selected so that a minimum leakage current and a maximum reliability of the capacitor are provided.

In an embodiment of the present invention, the sintering of the pellet can, for example, be followed by passivation of the sintered body by oxidation of the sintered body surface. For this purpose, the sintered body, after it has cooled to a temperature below 100° C., remains in the reactor. The passivation of the sintered body surface is then, for example, effected by the controlled and gradual introduction of oxygen into the reactor. The passivation can, for example, follow the sintering and follow a nitriding operation on the sintered body.

The oxide formed from the reducing agent can, for example, subsequently be washed out with the aid of dilute mineral acids.

The present invention further provides a sintered body obtainable by the process according to the present invention.

In an embodiment, the sintered body obtainable by the process according to the present invention has a BET surface area of 1.5 m²/g to 10 m²/g, for example, of 2 m²/g to 8 m²/g, and for example, of 3 m²/g to 6 m²/g. The BET surface area was determined to DIN ISO 9277.

In an embodiment of the present invention, the inventive sintered body can, for example, have a wire which can, for example, consist of or comprise a valve metal bonded to the sintered body, for example, pressed therewith. The valve metal can, for example, be selected from the group consisting of tantalum and niobium.

In an embodiment of the present invention, the inventive sintered body can, for example, have a wire, for example, consisting of valve metal, welded onto the sintered body. The valve metal can, for example, be selected from the group consisting of tantalum and niobium.

In an embodiment of the present invention, the sintered body obtainable by the process according to the present invention can, for example, have an oxygen content of 2000 ppm*g/m² to 4000 ppm*g/m², for example, of 2500 ppm*g/m² to 3500 ppm*g/m², for example, 2700 ppm*g/m² to 3500 ppm*g/m². The ppm figures are each based on parts by mass. The oxygen content was determined by carrier gas reactive fusion with the Nitrogen/Oxygen Determinator Model TCH 600 instrument from Leco Instrumente GmbH.

In an embodiment of the present invention, the sintered body can, for example, comprise sintering inhibitors, for example, selected from the group consisting of:
i) nitrogen in an amount below 300 ppm, for example, between 0.1 ppm and 300 ppm;
ii) boron in an amount below 10 ppm, for example, between 0.01 ppm and 10 ppm;
iii) sulfur in an amount below 20 ppm, for example, between 0.1 ppm and 10 ppm;
iv) silicon in an amount below 20 ppm, for example, between 0.01 ppm and 20 ppm;
v) arsenic in an amount below 10 ppm, for example, between 0.01 ppm and 10 ppm; and
vi) phosphorus in an amount below 20 ppm, for example, between 0.1 ppm and 20 ppm, where the ppm values are each based on parts by mass.

The inventive sintered bodies are suitable for electronic components, for example, for those in the mobile communications sector.

The present invention therefore further provides for the use of the inventive sintered body for electronic components, for example, capacitors.

The process according to the present invention is to be illustrated by the examples which follow, although the examples should not be understood as a restriction of the concept of the present invention.

### Examples

The tantalum powder was pressed with stearic acid as a pressing aid and a tantalum wire to give pellets with an embedded wire having a pressed density of 6.0 g/cm³. The stearic acid was removed via alkaline hydrolysis (NaOH) and subsequent washing of the pellet with water. This was followed by washing with dilute acid. This achieved the effect that the pellet had a carbon content below 50 ppm and a sodium content below 20 ppm. Magnesium was heated in a reaction chamber. As soon as the desired temperature had been attained, the pellet within a basket made from perforated niobium sheet was introduced into the magnesium vapor. The exact temperature and the duration of the individual experiments is set forth in Table 2. The pellet which had been deoxidized and sintered in this way was passivated by the standard methods known to those skilled in the art. The MgO formed during the deoxidation was washed out of the sintered body with the aid of dilute sulfuric acid. To this end, the sintered body was placed onto a perforated niobium sheet which was introduced into a wash vessel that contained the dilute sulfuric acid. The mixture was stirred cautiously, so that the sintered bodies did not start to move.

The exact composition of the tantalum powders used is summarized in Table 1 and Table 1a.

TABLE 1
Powders Utilized for Examples 1 to 9

| | BET | O/BET¹ |
|---|---|---|
| | m²/g | ppm/(m²/g)* |
| Comparative powder² | 5.46 | 2418 |
| (Comparative Examples 1-4) | | |
| Powder 1 | 7.52 | 2992 |
| (Example 1-4) | | |
| Powder 2 | 5.92 | 4155 |
| (Example 5 + 6) | | |
| Powder 3 | 7.95 | 3044 |
| (Example 7 + 9) | | |

¹Oxygen content based on the specific surface area.
²Prepared according to the teaching of WO 2006/039999 A1.
*The ppm figures reported are each based on parts by mass.

The following values were also measured for the powders:

TABLE 1a*

| | Mg | O | H | N | C | P | As | B | Si | S |
|---|---|---|---|---|---|---|---|---|---|---|
| | ppm | ppm | ppm | ppm | ppm | ppm | ppm | ppm | ppm | ppm |
| Comparative | 40 | 13200 | 288 | 1445 | 14 | 89 | — | — | — | — |
| Powder² | | | | | | | | | | |
| (Comparative | | | | | | | | | | |
| Examples 1-4) | | | | | | | | | | |
| Powder 1 | 78 | 22500 | — | <300 | 11 | 5 | — | — | — | — |
| (Example 1-4) | | | | | | | | | | |
| Powder 2 | — | 24600 | — | — | — | 7 | <1 | <1 | <3 | <10 |
| (Example 5 + 6) | | | | | | | | | | |
| Powder 3 | 55 | 24200 | — | <300 | <10 | 8 | | | | |
| (Example 7 + 9) | | | | | | | | | | |

*The ppm figures reported are each based on parts by mass.

The tantalum powders used in Examples 1 to 4 had an oxygen content of 2992 ppm*g/m², the powder used in Examples 5 and 6 an oxygen content of 4155 ppm*g/m², and the powder used in Examples 7 and 9 an oxygen content of 3044 ppm*g/m².

Table 2 shows the sintering conditions for the production of the sintered bodies. Inventive Examples 1 to 7 and 9 were produced by the process according to the present invention as described above.

The sintered bodies according to Comparative Examples 1-4 were sintered by standard methods under the conditions specified.

TABLE 2

| Example | Temperature/° C. | Time/minutes |
|---|---|---|
| Comparative Example 1* | 950 | 15 |
| Comparative Example 2* | 1050 | 15 |
| Comparative Example 3* | 1160 | 10 |
| Comparative Example 4* | 1120 | 15 |
| Example 1 | 950 | 15 |
| Example 2 | 1000 | 15 |
| Example 3 | 1050 | 15 |
| Example 4 | 1050 | 30 |
| Example 5 | 950 | 15 |
| Example 6 | 1000 | 15 |
| Example 7 | 950 | 15 |
| Example 9 | 950 | 15 |

*The sintering was effected under reduced pressure.

The sintered bodies obtained in this way showed the compositions summarized in Table 3.

TABLE 3

| | Mg | O | H | N | C | P |
|---|---|---|---|---|---|---|
| | ppm | ppm | ppm | ppm | ppm | ppm |
| Comparative | — | — | — | — | — | — |
| Example 1 | | | | | | |
| Comparative | — | — | — | — | — | — |
| Example 2 | | | | | | |
| Comparative | 27 | 21100 | — | 1352 | 20 | 64 |
| Example 3 | | | | | | |
| Comparative | — | — | — | — | — | — |
| Example 4 | | | | | | |
| Example 1 | 24 | 10600 | 307 | 204 | 34 | — |
| Example 2 | 22 | 7731 | 209 | 216 | 20 | — |
| Example 3 | 21 | 5711 | 132 | >300 | 44 | — |
| Example 4 | 18 | 5162 | 75 | 189 | 28 | — |
| Example 5 | 22 | 10500 | 301 | 201 | 36 | — |
| Example 6 | 17 | 7620 | 202 | 207 | 17 | — |

The sintered bodies obtained by the processes according to the present invention also had the properties summarized in Table 4:

TABLE 4

| | BET | O/BET¹ | PD² | SD³ | | WPS⁴ |
|---|---|---|---|---|---|---|
| | m²/g | ppm/(m²/g)* | g/cm³ | g/cm³ | Shrinkage | N |
| Comparative | — | — | 6.2 | 6.05 | −3% | 3 |
| Example 1 | | | | | | |
| Comparative | — | — | 6.14 | 6.08 | −1% | 3 |
| Example 2 | | | | | | |
| Comparative | 2.81 | 7509 | 6.0 | 6.49 | 8% | 11.3 |
| Example 3 | | | | | | |
| Comparative | — | — | 6.14 | 6.25 | 2% | 5.3 |
| Example 4 | | | | | | |
| Example 1 | 3.34 | 3174 | 6.0 | 5.89 | −3% | 2.7 |
| Example 2 | 2.45 | 3156 | 6.1 | 6.09 | 0% | 4.1 |
| Example 3 | 1.84 | 3104 | 6.1 | 6.4 | 5% | 7.4 |
| Example 4 | 1.57 | 3288 | 6.1 | 6.4 | 5% | 9.5 |
| Example 5 | 3.37 | 3116 | 6.05 | 5.99 | −1% | 4.6 |
| Example 6 | 2.46 | 3098 | 6.05 | 6.34 | 5% | 11 |

¹Oxygen content based on the specific surface area.
²PD: pressed density.
³SD: sinter density.
⁴WPS: wire pull strength (pull-out strength of the wire embedded in the anode body).
*The ppm figures reported are each based on parts by mass.

The bonding of the wire to the sintered body, i.e, the “wire pull strength” (WPS) was determined as follows: the anode wire was inserted through an orifice of diameter 0.25 mm of a holder plate and the free end was clamped into the holding clamp of a force gauge (Chatillon, model: DFGS-50 with LTCM-6 drive), and was subjected to a load until the wire was pulled out of the anode structure, i.e., the sintered body.

The sintered bodies were dipped into 0.1% phosphoric acid and formed at a current limited to 150 mA/g up to a formation voltage of 10 V (Comparative Examples 1 to 4 and Examples 1 to 6) or 17.5 V (Comparative Example 3a and Examples 8 and 10). For the forming of the sintered body declared as Example 10, an aqueous electrolyte to which 5% by weight of sulfuric acid and 0.5% by weight of hydrogen peroxide had been added was used, where the weight figures are each based on the total weight of the aqueous electrolyte, and the forming voltage was 17.5 V. After the current dropped, the voltage was maintained for three hours.

The results of the analysis with regard to the wire bonding in the individual process steps are summarized in Table 5. As can be inferred from Table 5, a sintered body which has been produced from a powder according to Table 1, Example 3, after the oxidized reducing agent has been washed out, has very low wire bonding (Example 7), which means that the sintered body has a high susceptibility to mechanical stress. The wire bonding rises again after the forming at 17.5 V (Example 8). In contrast, a sintered body directly after the deoxidation has relatively high wire bonding (Example 9). As can be inferred from Example 10, the high wire bonding can be obtained when the sintered body is subjected, directly after the deoxidation, to a combined washing and forming step, wherein 5% by weight of sulfuric acid and 0.5% by weight of hydrogen peroxide are added to the aqueous electrolyte. In this way, lowering of the wire bonding during the process is avoided. It is thus possible to dispense with one process step, which makes the process for producing the sintered bodies less time-consuming and more cost-effective. The sintered body furthermore has high wire bonding over the entire period, as a result of which any damage by mechanical stress, for example, the wire being pulled out, is avoided.

TABLE 5

| | WPS |
|---|---|
| Example 7 | 2.9 |
| Example 8 | 16.5 |
| Example 9 | 13.8 |
| Example 10 | 18.6 |

As can be inferred from Table 7, the combined washing and forming step does not have any adverse effects on the electrical properties of the sintered bodies (Table 7, Example 10). The data registered are instead within a range comparable to those for sintered bodies where the removal of the oxidized reducing agent and the forming is undertaken in two separate process steps (Table 7, Example 8). The sintered body for which electrical properties have been recorded as a comparative example in Table 7 as Comparative Example 3a was produced analogously to Comparative Example 3, using a forming voltage of 17.5 V.

For the capacitance measurements, a cathode composed of 18% sulfuric acid was used. Measurement was effected with AC voltages at 20 Hz and 120 Hz with simultaneous application of a bias voltage of 1.5 V.

For the sintered bodies thus obtained, the properties summarized in Table 6 were found.

TABLE 6

| | 1.5 V bias | | | | | |
|---|---|---|---|---|---|---|
| | 20 Hz | | 120 Hz | | | mea- |
| | μFV/cm³ | μFV/g | μFV/cm³ | μFV/g | μA/g | sured |
| Comparative | — | — | — | — | — | 0/10 |
| Example 1 | | | | | | |
| Comparative | 1352600 | 226946 | 1302400 | 218523 | 43.9 | 2/10 |
| Example 2 | | | | | | |
| Comparative | 1132572 | 173351 | 1093891 | 167430 | 62.6 | 10/10 |
| Example 3 | | | | | | |
| Comparative | 1124152 | 179861 | 1082188 | 173147 | 62.6 | 9/10 |
| Example 4 | | | | | | |
| Example 1 | 842960 | 145944 | 824460 | 143264 | 27.6 | 9/10 |
| Example 2 | 623600 | 97709 | 614800 | 96329 | 23 | 10/10 |
| Example 3 | 578175 | 90126 | 570238 | 88882 | 24 | 10/10 |
| Example 5 | 850741 | 143556 | 827778 | 139688 | 33.5 | 10/10 |

TABLE 7

| | 1.5 V bias | | | | | |
|---|---|---|---|---|---|---|
| | 20 Hz | | 120 Hz | | | mea- |
| | μFV/cm³ | μFV/g | μFV/cm³ | μFV/g | μA/g | sured |
| Comparative | 1132572 | 173351 | 1093891 | 167430 | 62.6 | 10/10 |
| Example 3a | | | | | | |
| Example 8 | 834609 | 148186 | 779622 | 138423 | 40.9 | 10/10 |
| Example 10 | 808041 | 142344 | 792690 | 139636 | 38.4 | 10/10 |

As can be inferred from the data set forth, the oxygen content in the sintered bodies produced is much lower than in sintered bodies obtainable by the current standard methods. Sintered bodies which were produced by the process according to the present invention also do not show the usual disadvantage of a reduced tear-out resistance of the wire embedded in the anode body. The inventive combination of washing of the sintered body after the deoxidation and the forming of the sintered body can additionally avoid a temporary drop in wire bonding during the process. The sintered bodies also have a lower leakage current.

As can be inferred from the values in Table 4, the sintered bodies which were produced using a tantalum powder having a relatively high oxygen content (4155 ppm*g/m²) have better wire bonding than sintered bodies which have been produced using a tantalum powder with an oxygen content customary in the art (2992 ppm*g/m²). As is known to the person skilled in the art, the wire bonding is greatly influenced by the sintering conditions. It is therefore only possible to compare sintered bodies which were sintered under the same conditions. The comparison of Example 1 with Example 5 and the comparison of Example 2 with Example 6 thus shows the improvement in wire bonding achieved in accordance with the present invention.

It has additionally been found that the Comparative Examples have much higher leakage current than the comparable inventive sintered bodies. It is additionally found that the sintered body produced at low temperatures according to Comparative Example 1 did not have adequate bonding to conduct measurements of the electrical properties. Comparative sintered bodies 2 also provided only 2 of 10 sintered bodies which were suitable for measurement.

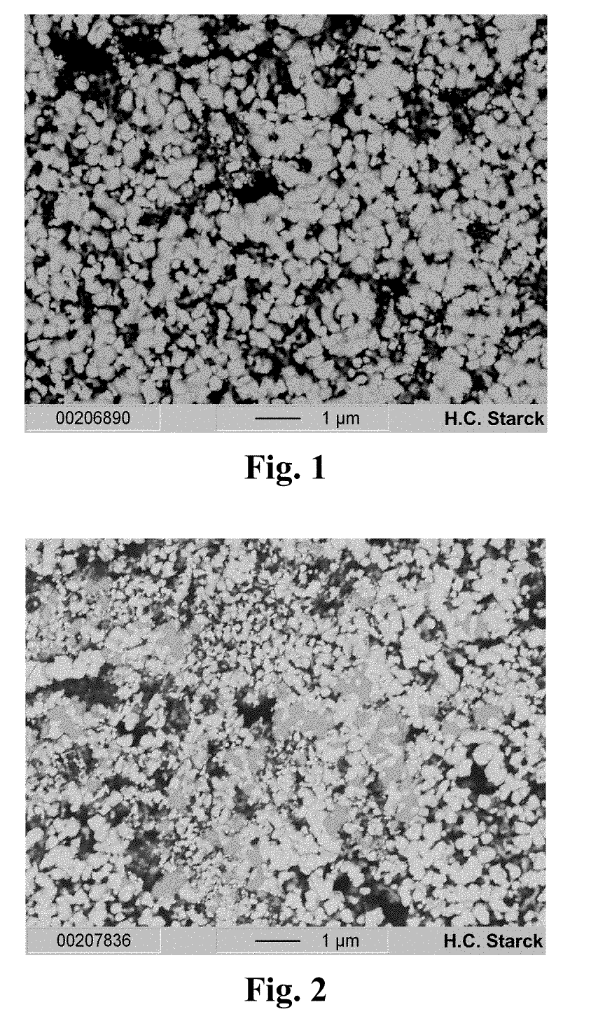

The microscope images shown in FIGS. 1 and 2 show, via the element contrast, the pores of the sintered body in black, the tantalum oxide deposits in grey, and the tantalum in white.

As apparent in FIG. 2, the proportion of grey regions is high, which indicates a distinct proportion of tantalum oxide. In contrast, these grey regions are completely absent in the image according to FIG. 1, which shows that the inventive sintered bodies have a much lower proportion of tantalum oxide.

The present invention is not limited to embodiments described herein; reference should be had to the appended claims.

What is claimed is:

1. A sintered body obtainable by a process comprising:
pressing a powder comprising or consisting of at least one valve metal so as to provide a pellet;
providing the pellet together with a reducing agent so that the pellet is not in a direct contact with and does not come into a direct contact with the reducing agent;
heating so that the powder in the pellet is sintered to form a sintered body, an oxygen content of the at least one valve metal within the sintered body is simultaneously reduced, and the reducing agent is oxidized to an oxidized reducing agent; and
removing the oxidized reducing agent with at least one mineral acid.

2. The sintered body as recited in claim 1, wherein the sintered body comprises a BET surface area of 1.5 to 10 m²/g.

3. The sintered body as recited in claim 1, wherein the sintered body comprises an oxygen content of 2000 to 4000 ppm·g/m².

4. The sintered body as recited in claim 1, wherein the sintered body comprises a sintering inhibitor selected from:
nitrogen in an amount below 300 ppm,
boron in an amount below 10 ppm,
sulfur in an amount below 20 ppm,
silicon in an amount below 20 ppm,
arsenic in an amount below 10 ppm, and
phosphorus in an amount below 20 ppm,
wherein, the ppm values are each based on parts by mass.

5. The sintered body as recited in claim 4, wherein the sintering inhibitor is selected from:
nitrogen in an amount between 0.1 ppm and 300 ppm,
boron in an amount between 0.01 ppm and 10 ppm,
sulfur in an amount between 0.1 ppm and 10 ppm,
silicon in an amount between 0.01 ppm and 20 ppm,
arsenic in an amount between 0.01 ppm and 10 ppm, and
phosphorus in an amount between 0.1 ppm and 20 ppm,
wherein, the ppm values are each based on parts by mass.

6. A method of using the sintered body as obtained in claim 1 for an electronic component, the method comprising:
performing the method as recited in claim 1 so as to obtain the sintered body;
providing the electronic component; and
using the sintered body for the electronic component.

7. A valve metal powder comprising:
oxygen in an amount of more than 4100 ppm·g/m²,
nitrogen in an amount below 300 ppm,
boron in an amount below 10 ppm,
sulfur in an amount below 20 ppm,
silicon in an amount below 20 ppm,
arsenic in an amount below 10 ppm, and
phosphorus in an amount below 20 ppm,
wherein, the ppm values are each based on parts by mass.

8. The valve metal powder as recited in claim 7, wherein the valve metal powder comprises:
oxygen in an amount between 4100 ppm·g/m² and 8000 ppm·g/m²,
nitrogen in an amount between 0.1 ppm and 300 ppm,
boron in an amount between 0.01 ppm and 10 ppm,
sulfur in an amount between 0.1 ppm and 10 ppm,
silicon in an amount between 0.01 ppm and 20 ppm,
arsenic in an amount between 0.01 ppm and 10 ppm, and
phosphorus in an amount between 0.1 ppm and 20 ppm,
wherein, the ppm values are each based on parts by mass.

9. The valve metal powder as recited in claim 7, wherein the valve metal powder has a BET surface area of 1.5 m²/g to 20 m²/g.

10. A sintered body obtainable by a process comprising:
pressing a powder comprising or consisting of at least one valve metal so as to provide a pellet around a wire, the wire being made from at least one valve metal;
providing the pellet together with a reducing agent so that the pellet is not in a direct contact with and does not come into a direct contact with the reducing agent;
heating so that the powder in the pellet is sintered to form a sintered body, an oxygen content of the at least one valve metal within the sintered body is simultaneously reduced, and the reducing agent is oxidized to an oxidized reducing agent; and
removing the oxidized reducing agent with at least one mineral acid,
wherein,
the powder comprising or consisting of the at least one valve metal comprises an oxygen content of >4,100 ppm·g/m², and
the sintered body comprises a wire pull strength of 2.7 to 11, the wire pull strength being determined by inserting the wire through an orifice of a holder plate having a diameter of 0.25 mm, clamping a free end of the wire into a holding clamp of a force gauge, and subjecting the free end to a load until the wire is pulled out of the sintered body.
